(19) United States
(12) Patent Application Publication
(10) Pub. No.: US 2024/0375329 A1
(43) Pub. Date: Nov. 14, 2024

(54) PRODUCING FOAM BODIES

(71) Applicant: KINGSPAN HOLDINGS (IRL) LIMITED, Cavan (IE)

(72) Inventors: Peter HOBBS, Hertfordshire (GB); Sandra FONTES, Hertfordshire (GB); Jonathan BURNS, Hertfordshire (GB)

(21) Appl. No.: 18/292,261

(22) PCT Filed: Jul. 27, 2022
(86) PCT No.: PCT/EP2022/071133

§ 371 Date: Jan. 25, 2024

(30) Foreign Application Priority Data
Jul. 27, 2021 (GB) 2110807.7

(51) Int. Cl. B29C 44/56; B29C 44/34; B29L 7/00; C08J 9/14

(52) U.S. Cl. CPC B29C 44/5609; B29C 44/3446; C08J 9/145; C08J 9/146; B29L 2007/002; C08J 2203/142; C08J 2203/162; C08J 2205/052; C08J 2205/10; C08J 2300/10

(57) ABSTRACT

The invention relates to a method for manufacturing a foam body, such as a foam insulation board, comprising the steps of: (i) providing foam reactant materials which react to form a foam body; (ii) providing a blowing agent; (iii) expanding, during reaction of the foam reactant materials, the foam reactant materials, using the blowing agent so as to form a foam body having cells defined therein and within which cells blowing agent is trapped; and (iv) collecting blowing agent not trapped within the foam body. Also disclosed herein is an apparatus for manufacturing a foam body. The collected blowing agent can be recycled/reused.

### FIELD OF THE INVENTION

The present invention relates to a process for production of foam bodies such as insulation foams used for thermal insulation. Of particular interest are thermally insulating foam boards. A continuous process for production of same is also of interest.

### BACKGROUND TO THE INVENTION

The production of foam boards or laminates is a well-known process. These are typically produced as a continuous body of foam on a production line. The continuous body is cut in desired lengths. Facers etc. can be applied during production. Typically reactants are mixed together to form a foam body. A blowing agent is used to expand the foam body. Blowing agent is trapped within the foam body, typically within closed cells within the foam body.

In such a process it is desired to maximise efficiency of production. For example, there should be as little as possible waste and the foam bodies produced must meet certain quality control standards. Given the volume of boards that can be produced, any savings in waste/materials etc. could be substantial.

Accordingly it is desirable to provide a method of manufacture that minimises waste in production.

### SUMMARY OF THE INVENTION

The present invention provides a method for manufacturing a foam body, such as a foam insulation board, comprising the steps of: (i) providing foam reactant materials which react to form a foam body; (ii) providing a blowing agent; (iii) expanding, during reaction of the foam reactant materials, the foam reactant materials, using the blowing agent so as to form a foam body having cells defined therein and within which cells blowing agent is trapped; and (iv) collecting blowing agent not trapped within the foam body.

The amount of blowing agent collected can be quite considerable, resulting in substantial savings. Also the collected blowing agent can be recycled and reused. For example, there may be a continuous recycling of blowing agent so that blowing agent collected from earlier production can be utilised again in later production. This way a minimum of blowing agent is lost and efficiency is increased.

Suitably, the step of collecting blowing agent comprises collecting blowing agent as a gas. Blowing agent that is liquid at, or close to, room temperature is in gaseous form when in use to expand the foam body. For example the reaction of the reactants that form the foam body may take place in a heated enclosure.

Desirably, the step of collecting blowing agent comprises collecting blowing agent as part of a gaseous mixture. It may not be possible to collect only blowing agent even if a single component blowing agent was used. For example water vapour and/or air may be collected also.

Accordingly the method of the invention may further comprise the step of separating blowing agent from a mixture collected. Optionally the blowing agent is collected as a mixture with water vapour. It may then be separated from water vapour, for example when the blowing agent and the water are in a liquid state. Suitably the blowing agent and water in a liquid state are immiscible and thus can be separated by gravity. For example, the mixture may be fed into a decanter in which it is separated into aqueous and organic fractions.

It is desirable to reuse the collected blowing agent in the manufacture of a foam body. For example it desirable to continually collect and to continually reuse blowing agent. A method of the invention therefore desirably further comprises reusing collected blowing agent in manufacture of a foam body.

In a method of the invention the collected blowing agent may be continuously reused in the manufacture of a foam body by a method of the invention as set out herein.

The blowing agent desirably comprises at least one of the following: hydrocarbon, halogenated hydrocarbon, hydrofluoroolefin, chlorinated hydrofluoroolefin or any combination thereof. Binary and ternary combinations of blowing agents are desirable.

The blowing agent may comprise hydrocarbon such as a C₃-C₆ hydrocarbon, for example butane, for example isobutane, and/or pentane, desirably isopentane or combinations thereof.

The blowing agent may additionally or alternatively comprise an unsaturated C₃-C₆ hydrocarbon for example butene, or pentene such as isopentene, or combinations thereof.

The blowing agent may additionally or alternatively comprise hydrofluoroolefin (HFO).

The blowing agent may comprise chlorinated hydrofluoroolefin, for example 1-chloro-3,3,3-trifluoropropene (1233zd) or 1-chloro-2,3,3,3-tetrafluoropropene (1224yd) or combinations thereof.

The blowing agent may additionally or alternatively comprise halogenated hydrocarbon such as isopropyl chloride.

The blowing agent may be a blend of at least two different blowing agents. For example the blowing agent may be a blend of hydrocarbon and hydrofluoroolefin and/or chlorinated hydrofluoroolefin.

The blowing agent may be a blend of hydrocarbon and halogenated hydrocarbon.

Suitably where the blowing agent is a blend, blowing agent not trapped within the foam body is collected as a blend. Suitably the method of the invention collects (and reuses) the blend in the same ratio as the blowing agents were mixed for use in a method of the invention. This means the blowing agent blend can be used again without any requirement for re-blending.

For example the blowing agent may be an azeotropic blend of at least two blowing agents. Where it is an azeotrope the blowing agent may be recovered by condensing it (or allowing it to condense) at a given temperature. Azeotropic mixtures are generally easier to recover in the same ratio as they were blended.

The method of the invention can be utilised for any foam body production, especially for thermal insulation including polyurethane (PU), polyisocyanurate (PIR), polystyrene (including expanded (EPS) and extruded (XPS) polystyrene) and phenolic foam.

The method of the invention is particularly suitable where there is a hydrofluoroolefin as blowing agent.

For example, the blowing agent may comprise pentane and in particular isopentane and at least one hydrofluoroolefin such as 1233zd. The blowing agent may be a binary blend of those.

Desirably the foam reactant materials are materials which react to form a phenolic foam body. For example the foam reactant materials may include a phenolic resin. The phenolic resin may have a weight average molecular weight of from about 700 to about 2000, and/or wherein the phenolic resin has a number average molecular weight of from about 330 to about 800, such as from about 350 to about 700.

The phenolic resin may have a molar ratio of phenol groups to aldehyde groups in the range of from about 1:1 to about 1:3, suitably from about 1:1.5 to about 1:2.3.

The water content of the foam reactant materials which are optionally phenolic foam reactant materials may be in the range of from about from 5 wt % to 12 wt %, such as from 6 wt % to 10 wt %, based on the total weight of the foamable composition formed by mixing the foam reactant materials.

Desirably the phenolic resin has a water content in the range of from about 10 wt % to about 14 wt %.

Suitably the phenolic resin has a viscosity of from about 2,500 mPa·s to about 18,000 mPa·s when measured at 25° C., such as from about 2500 mPa·s to about 16,000 mPa·s when measured at 25° C. for example from about 4,000 mPa·s to about 8,000 mPa·s when measured at 25° C.

The blowing agent may be used in the method of the invention in an amount of from about 1 to about 20 parts by weight per 100 parts by weight of a resin, for example a phenolic resin, which forms part of the foam reactant materials.

The blowing agent is typically an organic blowing agent and collecting blowing agent not trapped within the foam body may comprise:
(i) collecting a mixture of the organic blowing agent and water released during manufacture of a foam body, and allowing the blowing agent and water to condense or cooling them to condense them (optionally by passing through a heat exchanger);
(ii) transferring the mixture of organic blowing agent and water into a reservoir optionally a decanter;
(iii) separating the mixture, or allowing the mixture to separate, into aqueous and organic fractions, optionally by decanting;
(iv) collecting the organic fraction.

The aqueous fraction may be subjected to a water polishing and/or air stripping process. This would purify any water collected so that it can be reused in a method of the invention or indeed other processes.

Collected blowing agent may be metered, for example by passing through a metering pump, before being reused within a method of manufacture of a foam body of the invention. Metering allows the amount of recycled blowing agent to be calculated so that it can be added back into a method of the production according to the invention in a desired/calculated amount.

Collected blowing agent may be subject to compositional analysis in order to establish its composition. For example, if a blowing agent blend is used, the ratio of components in the blend may be analysed. Additionally or alternatively, the purity of the blowing agent may be analysed, for example to determine if there is any residual water present. This can be used to determine if the blowing agent is suitable for re-use or requires further processing such as purification before being re-used.

Collected blowing agent may be passed through a heat exchanger in order to bring it to and/or maintain it at a target temperature typically a constant temperature. Suitably the collected blowing agent is passed through a heat exchanger to maintain a temperature below about 25° C., for example below about 20° C., for example below about 17° C. An appropriate temperature may be selected based on the properties of the blowing agent used. For example, the heat exchanger may be used to impart to the blowing agent/maintain a temperature below the boiling point of the blowing agent used and ensure that the blowing agent remains in a liquid state. As a specific example, if the blowing agent used comprises E-1-chloro-3,3,3-trifluoropropene (HCFO-1233zd(E)), which has a boiling point of 18.3° C., a heat exchanger may be used to impart/maintain a temperature below 17° C.

While it is desired to collect a blowing agent blend in the ratio in which it was mixed this may not be possible. In such a case the blend ratio may be adjusted before reusing the blowing agent. For example one blowing agent component may be added in an amount sufficient to bring the blowing agent blend ratio back to the desired ratio. The adjustments required may be determined by the results of compositional analysis of the collected blowing agent. Suitably the results of compositional analysis of the collected blowing agent are communicated to a metering pump or dispenser which adds one or more components in an amount depending on the composition determined. In this way a compensation can be applied to ensure the blowing agent recycled is not different in any material way from blowing agent which was not recycled.

The foam reactant materials may be mixed within a heated enclosure. For example formation of the foam product may occur within a heated oven. The production system may comprise upper and lower conveyor belts which run through the oven.

The foam reactant materials may be mixed on a conveyor system with upper and lower belts. The foam reactant materials may be discharged onto a conveyor system with upper and lower belts which pass into a heated oven, for example at 50 to 100° C. for approximately 2 to 15 minutes. The foam board thus formed may then be cut to a desired length.

The method of the invention may be used to produce a foam body comprising at least one facing. Suitably, the method of the invention may be used to produce a foam body comprising a board having an upper face and a lower face where a facing is applied to at least one face of the board. Desirably the facing is applied to both the upper and lower faces of the board.

One or more of the facings is pre-perforated. Desirably at least one of the facings may comprise a substantially gas impermeable material. The facing may comprise a metallic foil such as an aluminium foil. The facing may be a laminate such as a metallic foil laminated onto a glass tissue or a metallic foil laminated onto a Kraft paper. The facer may be a paper, a glass tissue or any other kind.

Where at least one facing is used, the foam reactant materials may be laid down on a base facing. Optionally an upper facing is lead over the foam reactant materials forming a ‘sandwich’ which may then be lead through a heated oven, for example at 50 to 100° C. for approximately 2 to 15 minutes. The foam board thus formed may then be cut to a desired length.

The invention further provides a foam body, such as a foam insulation board, produced by a method described herein. The foam body, which may be a foam insulation board, may have one or more of the following properties:
(a) a density of from about from 10 kg/m³ to about 100 kg/m³;
(b) a closed cell content of at least 85% as determined in accordance with ASTM D6226;
(c) a FIGRA_{0.2MJ} of 150 W/s or less (preferably 125 W/s or less, 120 W/s or less, or 110 W/s or less, or 100 W/s or less, or 95 W/s or less, or 90 W/s or less, or 85 W/s or less), when measured according to EN13823;
(d) a compressive strength in the range of from about 95 kPa to about 200 kPa as determined in accordance with EN826;
(e) a FIGRA_{0.4MJ} of 80 W/s or less, when measured according to EN13823;
(f) a thermal conductivity of 0.020 W/m·K or less, suitably of 0.018 W/m·K or less, preferably 0.0175 W/m·K or less, or 0.0170 W/m·K or less, or 0.0165 W/m·K or less, 0.0162 W/m·K or less when measured at a mean temperature of 10° C., in accordance with EN 13166:2012;
(g) a limiting oxygen index of 34% or more, preferably 35% or more, suitable 36% or more, such as 37% or more as determined in accordance with ISO 4589-2;
(h) a stable moisture content of from 3% to 5% by weight when determined at (23±2) ° C. and a relative humidity of (50±5)% in accordance with EN1249:1998.

The invention further provides an apparatus for manufacturing a foam body comprising a dispenser for dispensing foam reactant materials, a dispenser for dispensing a blowing agent, a reaction device (such as an oven with conveyor belts) in which the foam reactant materials can react so as to form a foam body having cells defined therein and within which cells blowing agent is trapped, and a collector for collecting blowing agent not trapped within the foam body, optionally as part of a mixture.

It is appreciated that such an apparatus can be used to run any method of the present invention.

An apparatus of the invention may further comprise a reuse system for reusing the collected blowing agent not trapped within the foam body. This may take the form of a continuous production device for continually reusing the collected blowing agent not trapped within the foam body.

An apparatus according to the invention may further comprise at least one condenser or heat exchanger for cooling the collected blowing agent not trapped within the foam body. If the blowing agent is collected as a gas, the apparatus may comprise a condenser for condensing the blowing agent and/or a heat exchanger for maintaining it below its boiling point.

An apparatus according to the invention may further comprise a reservoir for collected blowing agent (and optionally any other components it is collected with). Suitably, the apparatus comprises a decanter. If the blowing agent is collected as part of a mixture, the apparatus desirably comprises a decanter which can be used to separate the mixture into organic and aqueous fractions. Additionally or alternatively, the apparatus may comprise another means of separating blowing agent from a mixture, for example a distillation apparatus. It will be appreciated that if the blowing agent is a blend and it is desired to separate the components of the blend from each other this may be carried out also.

An apparatus according to the invention may further comprise at least one analytical instrument for analysing the composition of the collected blowing agent, optionally as part of a mixture. Suitably the at least one analytical instrument comprises a sampler, for example an autosampler, for taking samples of the collected blowing agent to be analysed.

An apparatus according to the invention may further comprise at least one pump. Suitably it comprises at least one metering pump. Desirably it comprises at least one metering pump which is in communication with an analytical instrument analyzing the composition of the collected blowing agent.

### BRIEF DESCRIPTION OF THE DRAWINGS

Embodiments of the invention will be described, by way of example only, with reference to the accompanying drawings in which:

FIG. 1 is a simplified representation of a method for manufacturing a foam body, such as a foam insulation board, comprising the steps of: (i) providing foam reactant materials which react to form a foam body; (ii) providing a blowing agent; (iii) expanding, during reaction of the foam reactant materials, the foam reactant materials, using the blowing agent so as to form a foam body having cells defined therein and within which cells blowing agent is trapped; and (iv) collecting blowing agent not trapped within the foam body;

FIG. 2 is a flowchart showing how the method of the present invention may be used to recycle residual blowing agent from a foam body production process;

FIG. 3 is a simplified representation of the steps to which the blowing agent not trapped within the foam body may be subjected in order to be reused in a second foam body manufacture process.

### DETAILED DESCRIPTION OF THE DRAWINGS

The phrase “at least one X selected from the group consisting of A, B, C and combinations thereof” is defined such that X includes: “at least one A” or “at least one B” or “at least one C”, or “at least one A in combination with at least one B”, or “at least one A in combination with at least one C” or “at least one B in combination with at least one C” or “at least one A in combination with at least one B and at least one C”.

The term “blowing agent” is defined as the propelling agent employed to blow the foamable composition for forming a foam. For example, a blowing agent may be employed to blow/expand a resin to form a foam.

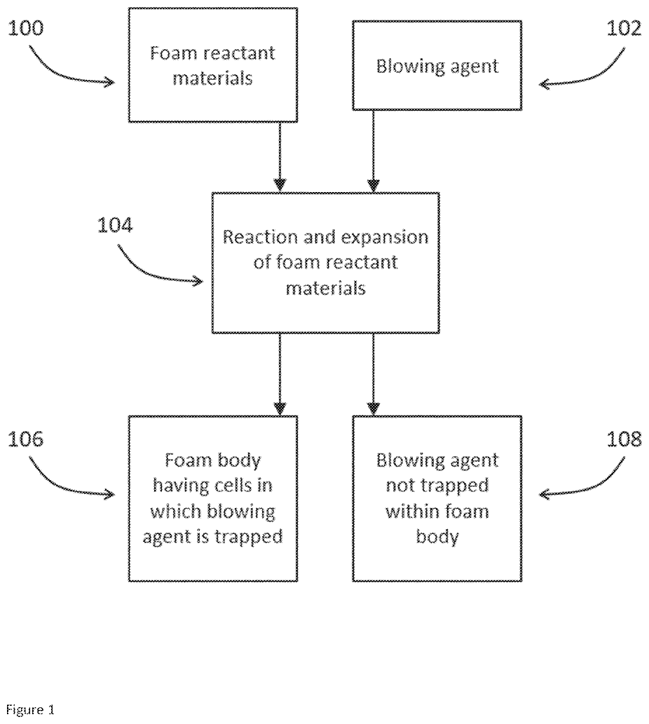

A simplified representation of a method according to the invention is shown in FIG. 1. The steps comprise providing foam reactant materials 100, providing a blowing agent 102, and expanding 104, during reaction of the foam reactant materials, the foam reactant materials using the blowing agent. This reaction and expansion 104 leads to the formation of a foam body 106 having cells defined therein, within which blowing agent is trapped, and the blowing agent 108 not trapped within the foam body is collected.

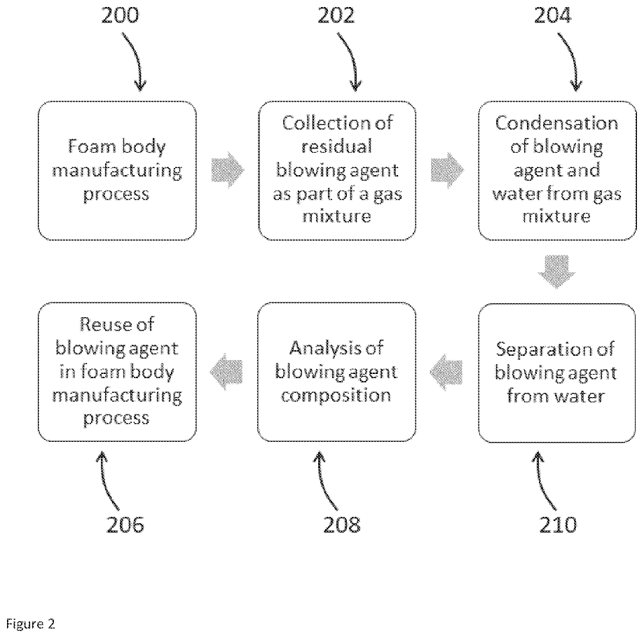

FIG. 2 shows how the blowing agent recovered by the method of the invention may be reused. Foam reactant materials and blowing agent are subjected to a foam body manufacturing process 200, during which the blowing agent not trapped within the foam body is collected 202 as part of a gas mixture. The gas mixture is cooled 204 in order to condense the blowing agent and any water vapour collected with it. The blowing agent and water are then separated 206. The composition of the collected blowing agent is analysed 208, and the collected blowing agent is then reused 210 in a further foam body manufacturing process.

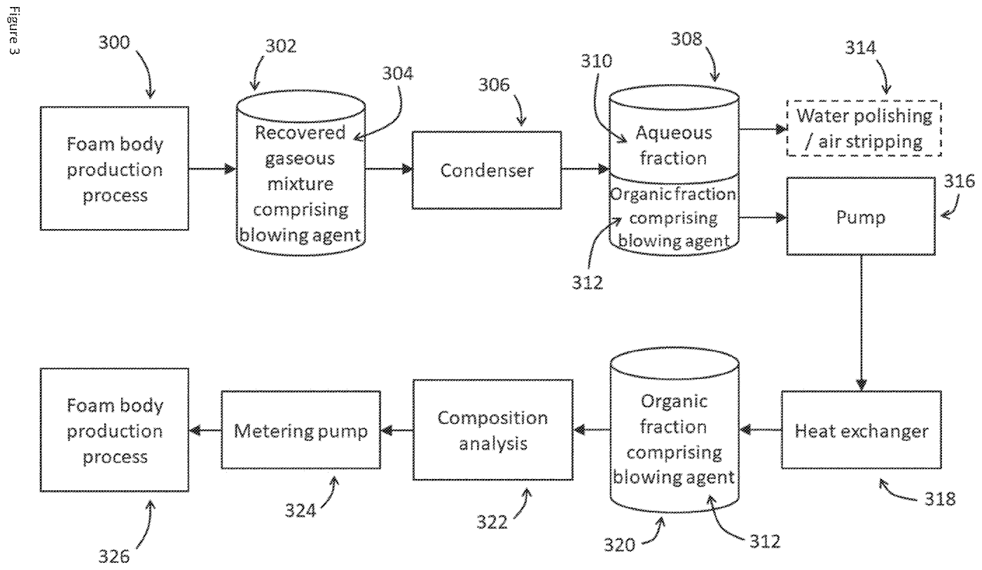

An illustration of the steps to which the collected blowing agent may be subjected in order to be reused in a second foam body manufacture process is shown in FIG. 3. Foam reactant materials and blowing agent are subjected to a foam body manufacturing process 300. The blowing agent not trapped within the foam body is recovered as part of a gaseous mixture 302 in a vessel 304. The gaseous mixture is passed through a condenser 306, in order to condense the blowing agent and any water vapour trapped, before being passed into a decanter 308. Within the decanter 308, the mixture separates into an aqueous fraction 310 and an organic fraction 312 comprising the blowing agent. Optionally, the aqueous fraction 310 is removed and subjected to a water polishing or air stripping process 314. The organic fraction 312 passes through a pump 316, which pumps it through a heat exchanger 318 and into a vessel 320. The organic fraction comprising the blowing agent is then subjected to compositional analysis 322 in order to determine its composition, before being introduced into a further foam body production process 326 via a metering pump 324.

The blowing agent not trapped within the foam body may be collected in a number of suitable ways depending on the foam body manufacturing process. For example, an extraction hood may be placed within/above the apparatus with which the foam body is made. Such an extraction hood may use an exhaust fan to pull a gas mixture of air and volatile organic solvents, including blowing agent(s), out of the vicinity of the foam body manufacturing process and optionally into a collection vessel.

The blowing agent may be collected within a gas mixture. Such a gas mixture may then be cooled in order to condense the blowing agent. For example, the gas mixture may be passed through a condenser and then the condensate collected as a liquid.

The blowing agent may be collected as a mixture with water vapour. Again, such a mixture may be cooled in order to condense the blowing agent, for example by passing it through a condenser. This may be done at a temperature where the blowing agent condenses and can be collected as a liquid, but where the water vapour remains in the gaseous state. Alternatively, the mixture may be cooled to a temperature where both the blowing agent and water vapour condense and can be collected as a liquid.

Where the blowing agent is collected within a gas mixture, it may then be separated from the mixture. As an example, where the blowing agent is collected as part of a mixture with water vapour, the mixture may be fed into a decanter in which it is separated into aqueous and organic fractions. The mixture may be fed into a decanter as a liquid after having been passed through a condenser. Alternatively, the mixture may be fed into a decanter as a gas and then cooled in situ in order to condense the mixture, at which stage it can be separated into organic and aqueous fractions.

Most common blowing agents are immiscible with water, so it is anticipated that a mixture of collected blowing agent and water will naturally separate into organic and aqueous fractions, for example after being fed into a decanter. The fractions can then be easily removed individually, for example via a tap at the bottom of the decanter (where the organic fraction is more dense than the aqueous fraction) or via a pump. However, if the blowing agent is miscible with water, then it may be separated from the mixture using other methods commonly known in the art, for example by distillation.

The organic fraction comprising collected blowing agent may be removed from the mixture and pumped through a heat exchanger. For example, a pump may be installed so as to pump the organic fraction out of the decanter, through a heat exchanger, and into a further vessel. The heat exchanger may be used to ensure a constant temperature of the organic fraction comprising collected blowing agent. An appropriate temperature may be selected based on the properties of the blowing agent used. For example, the heat exchanger may be used to maintain a temperature below the boiling point of the blowing agent used and ensure that the blowing agent remains in a liquid state. As a specific example, if the blowing agent used comprises E-1-chloro-3,3,3-trifluoropropene (HCFO-1233zd(E)), which has a boiling point of 18.3° C., a heat exchanger may be used to maintain a temperature below 17° C.

The organic fraction comprising collected blowing agent may undergo some type of composition analysis before being reused in further foam manufacture processes. Composition analysis may involve the measurement or determination of the components present and their densities, concentrations, or any other properties that can be measured with analytical tools commonly known in the art.

Composition analysis may be carried out on the organic fraction comprising collected blowing agent when it is in liquid phase, for example after having been passed through a condenser or through a heat exchanger to maintain a temperature below its boiling point. Alternatively, compositional analysis may be carried out when the organic fraction comprising collected blowing agent is in the gas phase.

Compositional analysis of the organic fraction comprising collected blowing agent may be carried out using any analytical methods or equipment commonly known to those in the field. For example, compositional analysis could be carried out using IR spectroscopy, NIR spectroscopy, or Raman spectroscopy. Alternatively, density and/or mass flowmeters could be used.

Composition analysis of the organic fraction comprising collected blowing agent may be carried out using an inline or online process analyser which allows for continuous analysis of a stream without the need for individual sampling. Alternatively, samples of the fraction may be taken, either manually or by an automated process, and analysis carried out offline.

The organic fraction comprising collected blowing agent may be reused as a blowing agent in the manufacture of a foam body. The crude organic fraction comprising collected blowing agent may be used as a blowing agent in the manufacture of a foam body, either with or without having first been subject to compositional analysis. Alternatively, the organic fraction comprising collected blowing agent may be mixed with at least one other component before being used as a blowing agent in the manufacture of a foam body.

If the composition of the organic fraction comprising collected blowing agent is known, for example if it has been subject to compositional analysis, it may be mixed with at least one other component in an amount or ratio determined by its composition. This may be done automatically, for example the equipment used for compositional analysis may be in communication with a further piece of equipment which may be used to add one or more further components, for example a metering pump, in an amount determined based on the output of the compositional analysis.

The at least one further component may be added to a vessel already containing the organic fraction comprising collected blowing agent. Alternatively the organic fraction comprising collected blowing agent may be added to a vessel already containing at least one further component. Alternatively the at least one further component and the organic fraction comprising collected blowing agent may be introduced simultaneously into a vessel.

The at least one further component and the organic fraction comprising collected blowing agent may be mixed or combined before being introduced into a process for the manufacture of a foam body. Alternatively the at least one further component and the organic fraction comprising collected blowing agent may simultaneously be added directly to a process for the manufacture of a foam body.

The method of the invention can be applied in the manufacture of any foam body. For example, the method is suitable for the production of polyisocyanurate foam bodies, polyurethane foam bodies, and phenolic resin foam bodies, among others. The type of foam body produced by the method of the invention can be determined by the choice of foam reactant materials.

Where the method is used for the manufacture of a phenolic resin foam body, the foam reactant materials used may comprise a foamable phenolic resin composition.

Similarly, the collected blowing agent can be reused in the manufacture of any foam body. For example, the collected blowing agent may be suitable for the production of polyisocyanurate foam bodies, polyurethane foam bodies, and phenolic resin foam bodies, among others.

The apparatus of the invention can be used for the manufacture of any foam body, for example for the production of polyisocyanurate foam bodies, polyurethane foam bodies, and phenolic resin foam bodies, among others.

The words “comprises/comprising” and the words “having/including” when used herein with reference to the present invention are used to specify the presence of stated features, integers, steps or components but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1-25. (canceled)

26. A method for manufacturing a foam body, such as a foam insulation board, comprising the steps of:
(i) providing foam reactant materials which react to form a foam body;
(ii) providing a blowing agent;
(iii) expanding, during reaction of the foam reactant materials, the foam reactant materials, using the blowing agent so as to form a foam body having cells defined therein and within which cells blowing agent is trapped; and
(iv) collecting blowing agent not trapped within the foam body.

27. A method according to claim 26 wherein collecting blowing agent comprises collecting blowing agent as a gas.

28. A method according to claim 26 wherein collecting blowing agent comprises collecting blowing agent within a gas mixture, for example as a mixture with water vapour.

29. A method according to claim 26 wherein the collected blowing agent is continuously reused in the manufacture of a foam body by a method as set out in claim 26.

30. A method according to claim 26 wherein the blowing agent comprises at least one of the following: hydrocarbon, halogenated hydrocarbon, hydrofluoroolefin, chlorinated hydrofluoroolefin or any combination thereof.

31. A method according to claim 26 wherein the blowing agent comprises hydrocarbon for example a C₃-C₆ hydrocarbon, for example butane, for example isobutane, and/or pentane, desirably isopentane or combinations thereof.

32. A method according to claim 26 wherein the blowing agent comprises an unsaturated C₃-C₆ hydrocarbon for example butene, or pentene such as isopentene, or combinations thereof.

33. A method according to claim 26 wherein the blowing agent comprises hydrofluoroolefin (HFO).

34. A method according to claim 26 wherein the blowing agent comprises chlorinated hydrofluoroolefin for example 1-chloro-3,3,3-trifluoropropene (1233zd) or 1-chloro-2,3,3,3-tetrafluoropropene (1224yd) or combinations thereof.

35. A method according to claim 26 wherein the blowing agent comprises halogenated hydrocarbon such as isopropyl chloride.

36. A method according to claim 26 wherein the blowing agent is a blend of at least two different blowing agents, suitably an azeotropic blend of at least two blowing agents.

37. A method according to claim 36 wherein the blowing agent is a blend of hydrocarbon and hydrofluoroolefin and/or chlorinated hydrofluoroolefin.

38. A method according to claim 36 wherein the blowing agent is a blend of hydrocarbon and halogenated hydrocarbon.

39. A method according to claim 26 wherein the foam reactant materials are materials which react to form a phenolic foam body.

40. A method according to claim 39 wherein the foam reactant materials include a phenolic resin and wherein the phenolic resin has one or more of the following properties:
a. a weight average molecular weight of from about 700 to about 2000;
b. a number average molecular weight of from about 330 to about 800, such as from about 350 to about 700;
c. a molar ratio of phenol groups to aldehyde groups in the range of from about 1:1 to about 1:3, suitably from about 1:1.5 to about 1:2.3;
d. a water content in the range of from about 10 wt % to about 14 wt %;
e. a viscosity of from about 2,500 mPa·s to about 18,000 mPa·s when measured at 25° C., such as from about 2500 mPa·s to about 16,000 mPa·s when measured at 25° C. for example from about 4,000 mPa·s to about 8,000 mPa·s when measured at 25° C.

41. A method according to claim 26 wherein the water content of the foam reactant materials which are optionally phenolic foam reactant materials is in the range of from about from 5 wt % to 12 wt %, such as from 6 wt % to 10 wt %, based on the total weight of the foamable composition formed by mixing the foam reactant materials.

42. A method according to claim 26 wherein the blowing agent is present in an amount of from about 1 to about 20 parts by weight per 100 parts by weight of a resin for example a phenolic resin which forms part of the foam reactant materials.

43. A method according to claim 26 wherein the blowing agent is an organic blowing agent and collecting blowing agent not trapped within the foam body comprises:
(i) collecting a mixture of the organic blowing agent and water released during manufacture of a foam body, and allowing the blowing agent and water to condense or cooling them to condense them optionally by passing through a heat exchanger;
(ii) transferring the mixture of organic blowing agent and water into a reservoir, optionally a decanter;
(iii) separating the mixture, or allowing the mixture to separate, into aqueous and organic fractions, optionally by decanting;
(iv) optionally, cooling the organic fraction to a temperature of below about 25° C., for example below about 20° C., for example below about 17° C., optionally by passing through a heat exchanger;
(v) collecting the organic fraction.

44. A method according to claim 26 wherein the collected blowing agent is metered, for example by passing through a metering pump, before being reused for example within a method of manufacture of a foam body according to claim 26.

45. A method according to claim 26 wherein the reactants are mixed within a heated enclosure and/or wherein the reactants are mixed on a conveyor system with upper and lower belts.

46. An apparatus for manufacturing a foam body comprising:
(i) a dispenser for dispensing foam reactant materials;
(ii) a dispenser for dispensing a blowing agent;
(iii) a device within which the reactant materials can react so as to form a foam body having cells defined therein and within which cells blowing agent is trapped;
(iv) a collector for collecting blowing agent not trapped within the foam body, optionally as part of a mixture;
(v) optionally, a reuse system for reusing the collected blowing agent not trapped within the foam body,
the reuse system for reusing the collected blowing agent not trapped within the foam body which comprises a continuous production device for continually reusing the collected blowing agent not trapped within the foam body.

47. An apparatus according to claim 46, further comprising at least one of the following:
a. a condenser or heat exchanger for cooling the collected blowing agent, optionally as part of a mixture;
b. a reservoir, optionally a decanter for separating a mixture comprising collected blowing agent into aqueous and organic fractions;
c. at least one analytical instrument for analyzing the composition of the collected blowing agent, optionally as part of a mixture.
